(19) United States
(12) Patent Application Publication
(10) Pub. No.: US 2013/0200849 A1
(43) Pub. Date: Aug. 8, 2013

(54) SYSTEM FOR MANAGING A SERIES COMBINATION OF ELECTRICAL ENERGY GENERATION OR STORAGE ELEMENTS, BASED ON A PLURALITY OF VOLTAGE INVERTER LEGS

(71) Applicants: Jean-Christophe Crebier, Grenoble (FR); Alexandre Chureau, Grenoble (FR)

(72) Inventors: Jean-Christophe Crebier, Grenoble (FR); Alexandre Chureau, Grenoble (FR)

(73) Assignees: CENTRE NATIONAL DE LA RECHERCHE SCIENTIFIQUE, Paris (FR); INSTITUT POLYTECHNIQUE DE GRENOBLE, Grenoble Cedex (FR)

(21) Appl. No.: 13/641,336

(22) PCT Filed: Apr. 12, 2011
(86) PCT No.: PCT/IB2011/051585

§ 371 Date: Mar. 25, 2013

(30) Foreign Application Priority Data
Apr. 15, 2010 (FR) 1001613

(51) Int. Cl. H02J 7/00

(52) U.S. Cl. CPC H02J 7/0042
USPC 320/116

(57) ABSTRACT

A management system for managing a series association of elements for storing and/or generating electrical energy (CA₂-CAₙ), the system being characterized in that it comprises:
first and second power bars (BP₁, BP₂);
a plurality of inverter arms (B₁-Bₙ₋₁) connected in parallel between said first and second power bars, each inverter arm being in turn constituted by two switches (Tₕ₁, T_{b1}) connected in series via a midpoint (PM₁) of the arm;
a plurality of inductors (L₁-Lₙ), each connected to the midpoint of a respective inverter arm; and
a plurality of connectors for connecting the midpoint of each inverter arm to said series association between two adjacent elements via a respective one of said inductors.

A series association of electrical energy storage and/or generator elements including such a management system.

The invention relates to a system for managing a series association of elements for generating and/or storing electrical energy, such as storage battery cells or storage battery units, supercapacitors, or photovoltaic cells. The invention also relates to a series association of elements for generating and/or storing electrical energy that is provided with such a management system. The invention also relates to the use of such a system for voltage and/or charge-level equalization of the elements of a system for storing electrical energy such as an electrochemical battery, or for providing the cells of a photovoltaic panel with current support and equalization. All of these operations, i.e. equalizing charge and/or voltage, equalizing and/or supporting current, short circuiting, and detecting failures, are referred to collectively herein by the general term “managing”.

As shown in FIG. 1, electrochemical batteries are generally of modular structure. The basic element is constituted by an individual storage cell A, comprising a single electrochemical cell. A plurality of storage cells connected in parallel form a storage unit CA; such a unit supplies the same voltage as an individual storage cell, but greater current. In order to increase the voltage level supplied by the battery, a plurality of storage units are connected in series, forming a so-called “module” M. A plurality of modules may in turn be connected in series to form a so-called “stack” S. A complete battery BATT is made up of a plurality of stacks connected in parallel.

The system of the invention seeks in particular to enable the various elements (cells, units, modules) of a battery that are mutually connected in series to be equalized in terms of voltage and/or charge.

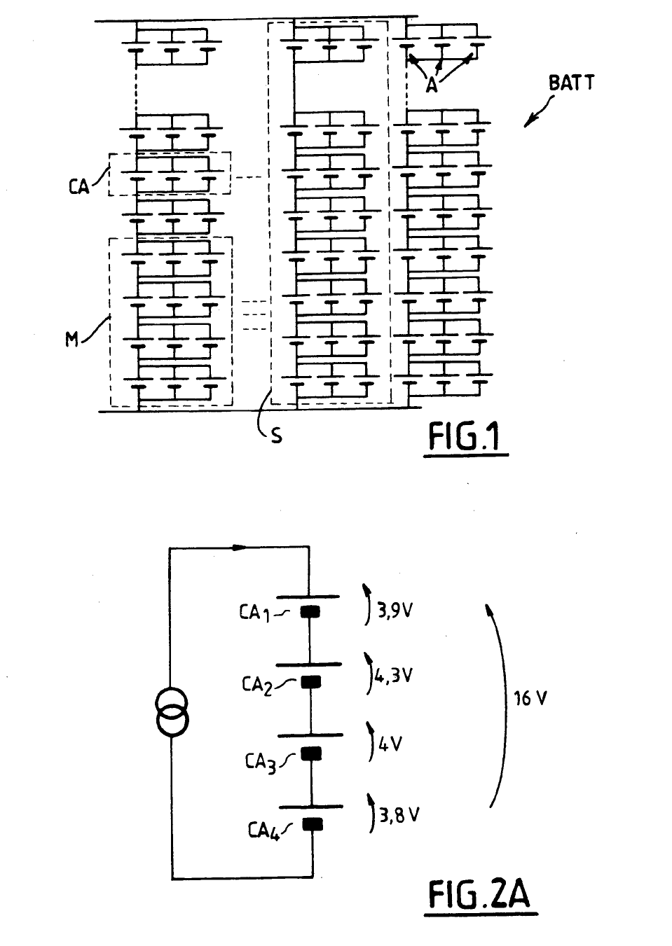

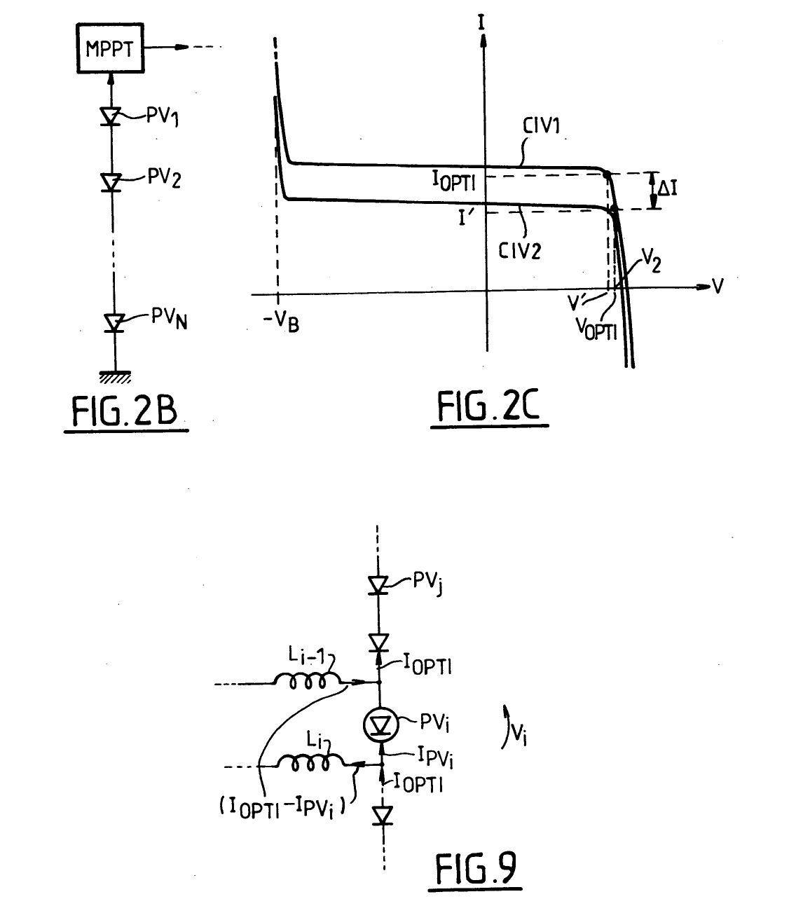

The problem of voltage balancing or “equalization” is shown in FIG. 2A which shows a battery made up of a series association of four units CA1, CA2, CA3, and CA4, which association is connected to a current generator in order to be charged. Ideally, all four units should be charged to the same voltage equal to 4 volts (V) so as to provide an overall voltage of 16 V across the terminals of the battery. In reality, dispersion phenomena exist in association with the fabrication, utilization, and aging conditions of the elements, and they have the effect that some of the elements charge or discharge more quickly than others. Thus, in the example of FIG. 2A, the elements CA1 and CA4 are charged to a voltage less than the nominal value of 4 V, while the element CA2 is charged to a value that is significantly higher (4.3 V) that might damage it. Conversely, the element CA4 is charged to a voltage of only 3.8 V; after prolonged use, this element is therefore likely to be taken into a state of deep discharge—also very damaging—that cannot be detected by measuring only the voltage across the terminals of the series association. These problems are particularly severe with lithium batteries, which are very sensitive to undercharging and to overcharging.

A similar problem also arises with a series association of photovoltaic cells, as is necessary for raising the voltage level delivered by a single cell. If one of the cells in the association presents a fault, or is merely exposed to a light flux that is less intense than the others (because its surface is dirty, or because it is shaded), a negative potential difference appears across its terminals, thereby greatly limiting the power level generated by the association as a whole.

FIG. 2B shows such a series association of photovoltaic cells PV₁, . . . , PV_{N} represented by reverse-biased diodes. A maximum power point tracker (MPPT) module connected in series with the cells determines the magnitude of the current flowing through the series association in such a manner as to maximize the power generated by the photovoltaic effect. In FIG. 2C, the curve CIV1 shows the voltage (V)−current (I) characteristic of photovoltaic cells exposed to the same light flux; curve CIV2 shows the characteristic of one cell that, starting from an instant T, finds itself exposed to a lower light flux, e.g. as a result of dirt.

For t<T, while all of the cells are illuminated in the same manner and therefore all of them follow the same characteristic CIV1, the module MPPT imposes a current I_{OPTI} through the series association, and a potential difference V_{OPTI} across the terminals of each cell, such that:

P_{OPTI}=V_{OPTI}·I_{OPTI}=max(V·I)

Starting from the instant t=T, one of the cells, PV_{B}, receives less light flux, so its characteristic becomes that of the curve CIV2.

If the current through the series association then remains equal to I_{OPTI}, the potential difference across the terminals of the shaded or dirty cell PV_{B} becomes negative and equal to −V_{B} (avalanche breakdown voltage). The loss of power is thus equal to:

ΔP₁=−I_{OPTI}(V_{OPTI} V_{B})

The module MPPT can react to this situation by reducing the current to the level:

I′=I_{OPTI}−ΔI

such that the cell PVᵢ begins to produce energy once more. Nevertheless, the total power is reduced to the level:

I′·[(n−1)·V₂+V′]

with a loss of power

ΔP₂=P′−P_{OPTI}

where V₂ is the voltage across the terminals of the cells PVⱼ (j≠i) for I=I′.

In any event, it is important to observe that merely reducing the illumination of a single photovoltaic cell significantly reduces the power generated by the series association.

To mitigate those drawbacks of series associations of elements for generating and/or storing electrical energy—where electrochemical storage cells and photovoltaic cells are merely non-limiting examples—it is necessary to provide management systems.

The state of the art includes several management systems, and in particular systems for voltage equalization, for use with elements for storing electrical energy, in particular electrochemical elements.

The most common equalizer systems are of the passive or dissipative type. During a charging stage, those systems act continuously or periodically to measure the potential difference across the terminals of each of the elements connected in series, and they divert current that can no longer be absorbed by the lower-capacity elements to a dissipation resistance. It can be understood that those systems lead to energy losses that are difficult to accept; if the characteristics of the various electrochemical elements present a large amount of dispersion, the size of the heat dissipaters can become prohibitive. Battery discharging must be stopped when the lowest-capacity elements have reached their acceptable low limit voltage; this means that the storage capacity of the battery is limited by the capacity of its worst elements.

There also exist active equalizer systems that redistribute currents within the battery instead of dissipating them. Thus, during a charging stage, those systems divert the current that can no longer be absorbed by the “weaker” elements to the “stronger” elements, for which storage capacity has not been used up. During a discharge stage, they take additional current from the stronger elements in order to compensate for the lack of current coming from the weaker elements. The main drawbacks of those systems are their complexity and their high cost.

The article by N. Kutkut and D. Divan “Dynamic equalization techniques for series battery stacks”, 18^{th} International Telecommunication Energy Conference, 1996 (INTELEC '96), pp. 514-521, describes several active equalizer systems.

Equalizer systems known in the prior art include a plurality of reactive elements, in particular inductors and/or magnetic couplers. In addition, their active components are difficult to integrate, in particular in high-power applications, in which it is necessary to make use of devices that are of vertical structure. Consequently, those systems are complex and bulky.

The problem of equalization or compensation in series associations of photovoltaic cells is known in particular from the article by T. Shimizu et al. “Generation control circuit for photovoltaic modules”, IEEE Transactions on Power Electronics, Vol. 16, No. 3, May 2001. That article proposes a first circuit based on using a magnetic coupler and performing equalization of a centralized type. That circuit is relatively bulky. The article also discloses a second equalization circuit, based on a multistage chopper circuit, which is relatively complex to control.

The article by T. Mishima and T. Ohnishi “Power compensation system for partially shaded PV array using electric double-layer capacitors”, 28^{th} Annual Conference of the IEEE Industrial Electronics Society (IECON 02), Nov. 5-8, 2002, Vol. 4, pp. 3262-3267, discloses an alternative equalization circuit for series associations of photovoltaic cells making use of capacitive storage of electrical energy. That circuit is both bulky, since it relies on using a plurality of banks of capacitors of relatively high capacitance, and complex to control.

The invention seeks to remedy the above-mentioned drawbacks of the prior art and to provide a management system of structure that is simple, that is easy to control, that has active components that are easy to integrate, and inductive components that are compact.

An aspect of the invention that enables this object to be achieved is a management system for managing a series association of elements for generating and/or storing electrical energy, the system being characterized in that it comprises:
first and second power bars;
a plurality of inverter arms connected in parallel between said first and second power bars, each inverter arm being in turn constituted by two switches connected in series via a midpoint of the arm;
a plurality of inductors, each connected to the midpoint of a respective inverter arm; and
a plurality of connectors for connecting the midpoint of each inverter arm to a point situated between two adjacent elements of said series association via a respective inductor.

In a first embodiment of the invention, the system may include a first connector for connecting the first power bar to a positive terminal of the electrical energy generator and/or storage element situated at a positive end of said series association, and a second connector for connecting the second power bar to a negative terminal of the electrical energy generator and/or storage element situated at a negative end of said series association. Under such circumstances, the number of inverter arms and the number of inductors is n−1, where n is the number of energy generator and/or storage elements to be equalized.

In a second embodiment of the invention, the system may include two inductors connected in series with said first and second connectors. The number of inductors is thus equal to n+1, while the number of inverter arms remains equal to n−1. The performance of such a system is better than that of the first embodiment; in particular, current oscillations within the storage and/or generator elements are considerably smaller.

In a third embodiment of the invention, the system may also include: an inverter arm connected between said first and second power bars, with its midpoint being connected via a respective inductor to a positive terminal of the electrical energy generator and/or storage element situated at a positive end of said series association; and an inverter arm connected between said first and second power bars, with its midpoint connected via a respective inductor to a negative terminal of the electrical energy generator and/or storage element situated at a negative end of said series association. The main advantage of this embodiment is to make it possible to “force” equalization of the elements.

According to advantageous characteristics of the invention:
Said inductors may all present the same inductance value.
More particularly, said inductors may be made in the form of coils around respective columns of a magnetic core having yokes in common, thus providing a single magnetic circuit. This makes it possible for all of the inductive components of the system to be brought together in a single element that is particularly compact.
The system may also include a capacitor connected between said first and second power bars.
The system may also include control means for controlling the switches of all or some of said inverter arms in alternating manner with a duty ratio selected in such a manner as to determine a mean voltage level for the midpoint of each of said inverter arms that is equal to a predetermined nominal voltage level.
In a variant, the system may include control means for controlling the switches of all or some of said inverter arms in alternating manner with a duty ratio selected in such a manner as to determine a level of current flowing through the midpoint of each of said inverter arms that is equal to a predetermined nominal current level.
Concerning the active components of the system: the switches of said inverter arms may be made in the form of semiconductor devices that are of vertical structure; and at least a plurality of said inverter arms are made in the form of two-chip modules comprising a first chip monolithically integrating the switches connected between the first power bar and the respective midpoints, and a second chip monolithically integrating the switches connected between said respective midpoints and the second power bar. Thus, all of said active components may be made in integrated manner, even when the power and voltage levels involved require the use of devices having a vertical structure. When it is possible to use devices having a lateral structure, the active portion of the system of the invention may be integrated monolithically without any particular difficulty.
Said inverter arms may be made using complementary MOS technology, or it may be based on N-type transistors (MOS transistors, IGBTs or diodes).
N of said inverter arms, where N>1, may be connected via their respective midpoints and via respective inductors to each of said connectors. Under such circumstances, the system may also include control means for periodically operating the inverter arms connected to a common conductor with an offset of 1/N^{th} of a cycle. Advantageously, N may be equal to the number of electrical energy storage or generator elements in said series association.

In other aspects, the invention also provides:
A hierarchical system for managing a series association of electrical energy storage or generator modules, each module being in turn constituted by a series association of electrical energy storage or generator elements, said system comprising: a plurality of management systems as described above for managing respective modules; and a management system based on flyback type converters for managing the series association of said modules, each being considered as being indivisible. Advantageously, said management system based on flyback type converters may comprise: a plurality of full-bridge inverters, each of which is constituted by two inverter arms connected in parallel between two end ports of the inverter, each inverter arm being in turn constituted by two switches connected in series by a said midpoint of the arm; a plurality of connectors for connecting the two end ports of each full-bridge inverter to a respective element of said series association; and a magnetic coupler formed by a magnetic core having a plurality of windings made thereon, each of said windings being connected to the midpoints of the arms of one of said inverters.
A series association of electrochemical elements for storing electrical energy, the association including a management system as described above.
The use of a system as described above for voltage and/or charge level equalization of elements of an electrochemical battery.
A photovoltaic panel comprising a series association of photovoltaic cells, connected to a management system as described above.
The use of a system as described above, for providing current equalization for a series association of photovoltaic cells or panels.
The use of a system as described above, for detecting a faulty or shaded photovoltaic cell or set of photovoltaic cells in a series association of such cells.
A set of photovoltaic panels connected to a management system as described above.

Other characteristics, details, and advantages of the invention appear on reading the description made with reference to the accompanying drawings given by way of example, and in which:

FIG. 1 shows the modular structure of an electrochemical battery;

FIG. 2A shows the problem of voltage equalization in a series association of electrochemical energy storage elements;

FIGS. 2B and 2C show the need for equalizer in a series association of photovoltaic cells;

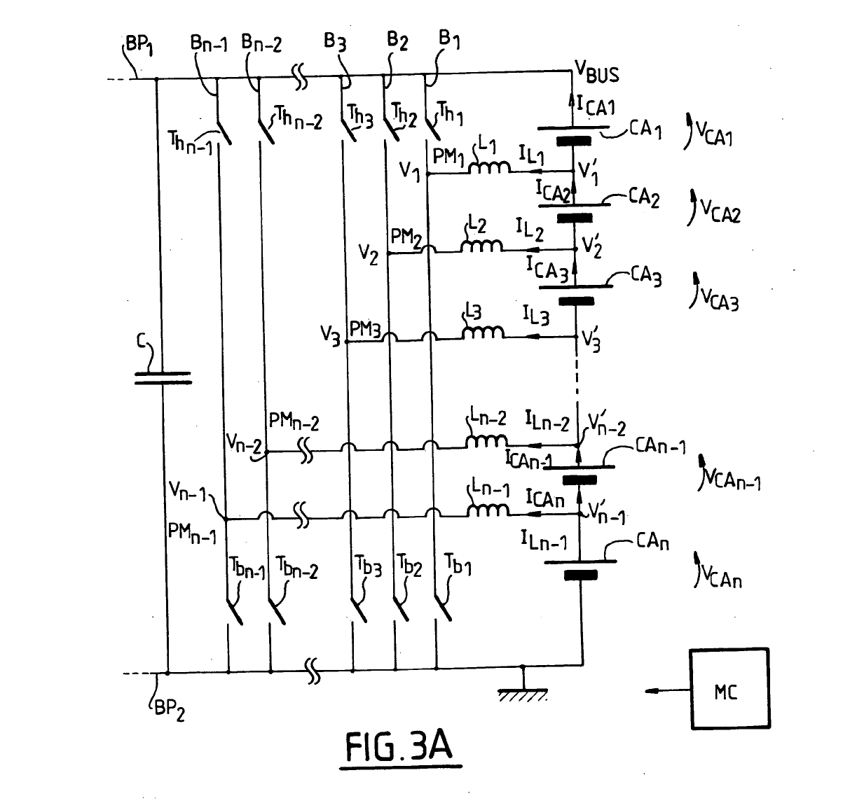

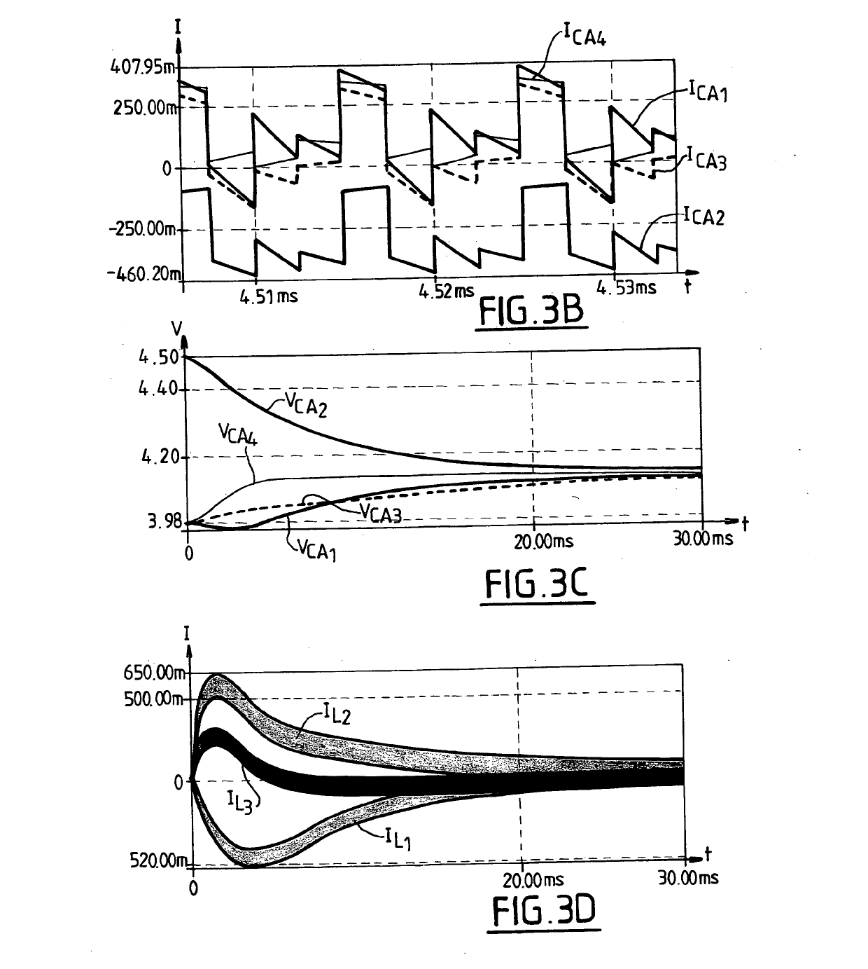

FIG. 3A shows the structure of an equalizer system in said first embodiment of the invention;

FIGS. 3B to 3D show the operation of the FIG. 3A system for voltage equalization of the FIG. 2A series association of energy storage elements;

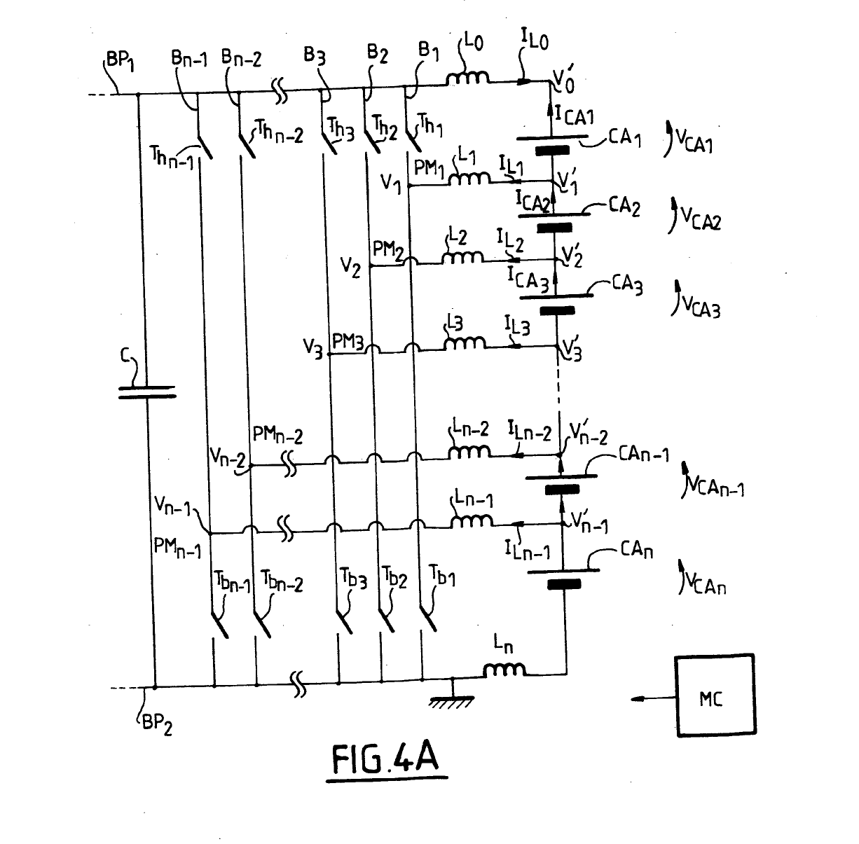

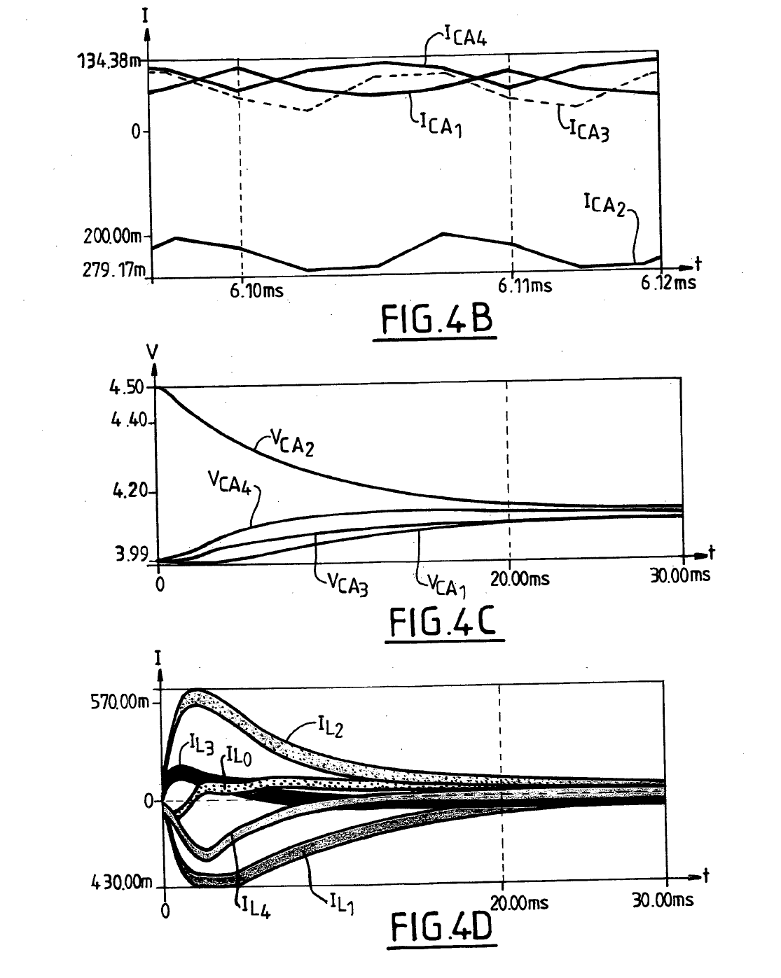

FIG. 4A shows the structure of a management system in said second embodiment of the invention;

FIGS. 4B to 4D show the operation of the FIG. 4A system for voltage equalization of the FIG. 2A series association of energy storage elements;

FIG. 5 shows the structure of a management system in said third embodiment of the invention;

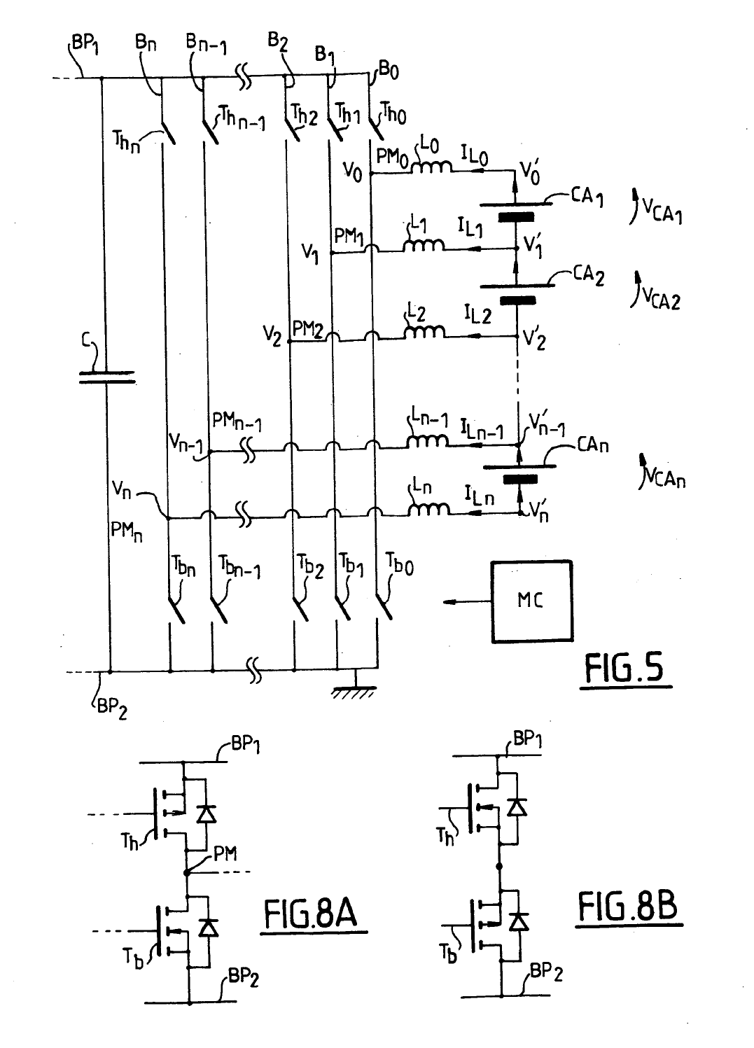

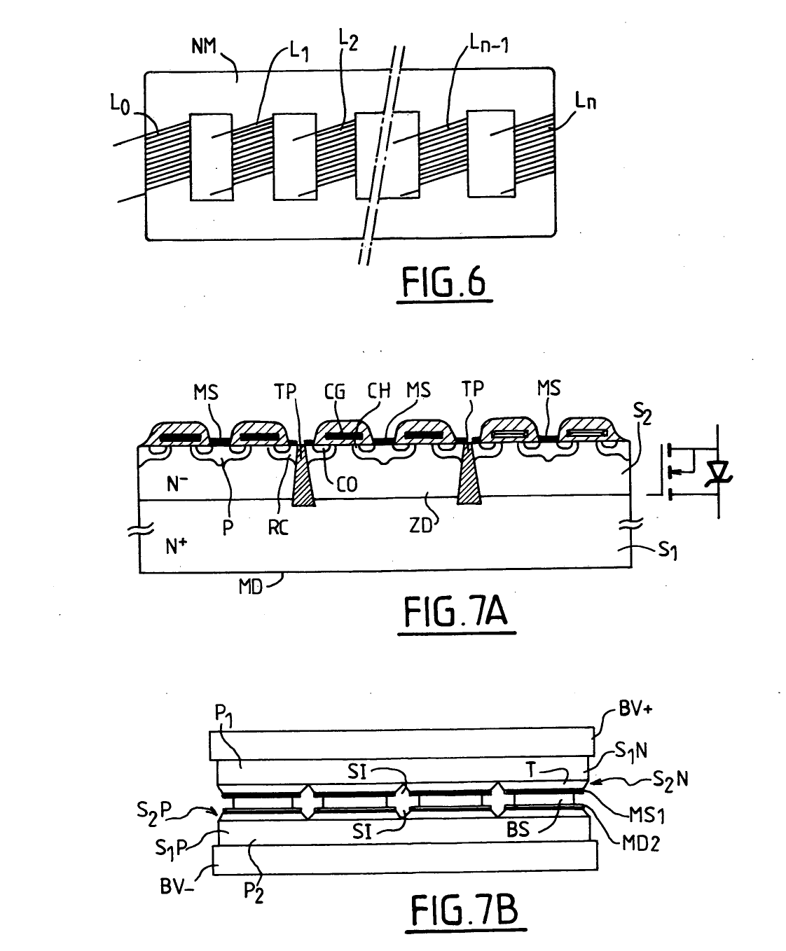

FIG. 6 shows how the inductors of a management system of the invention are made by using a magnetic core having shared yokes;

FIGS. 7A and 7B show how the active portion of a management system of the invention can be made in integrated manner in a high-voltage and high-power application that requires the use of components having a vertical surface;

FIGS. 8A and 8B are electric circuit diagram showing two variants of a voltage inverter arm made using complementary MOS technology;

FIG. 9 shows the operation of a system of the invention for equalizing a series association of photovoltaic cells;

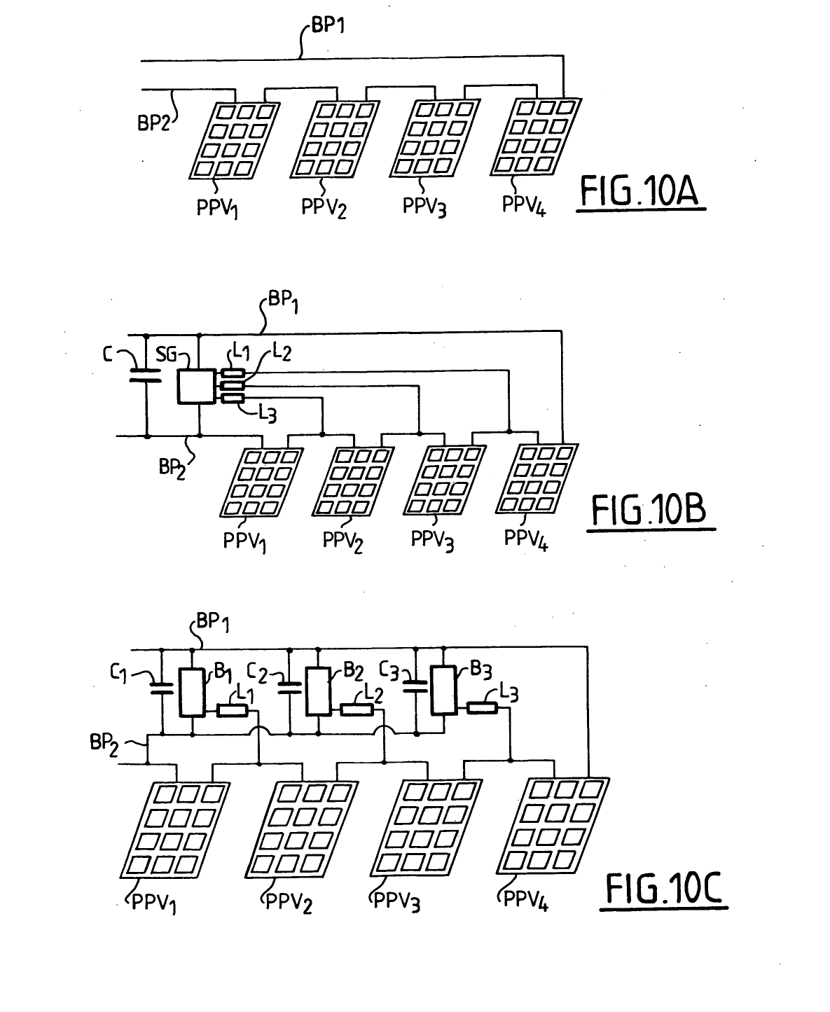

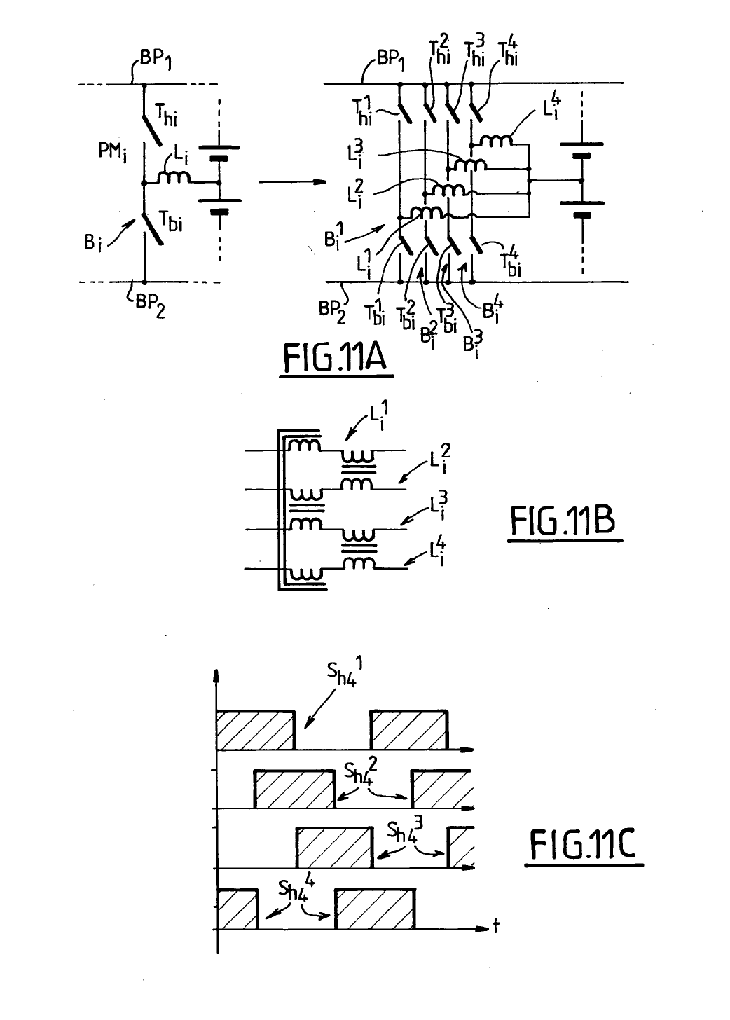

FIGS. 10A to 10C show the operation of a system of the invention for equalizing a series association of photovoltaic panels;

FIGS. 11A and 11B show two alternative embodiments of a system of the invention enabling the size of the reactive components to be reduced;

FIG. 11C shows switch control signals for management systems of the embodiments of FIGS. 11A and 11B;

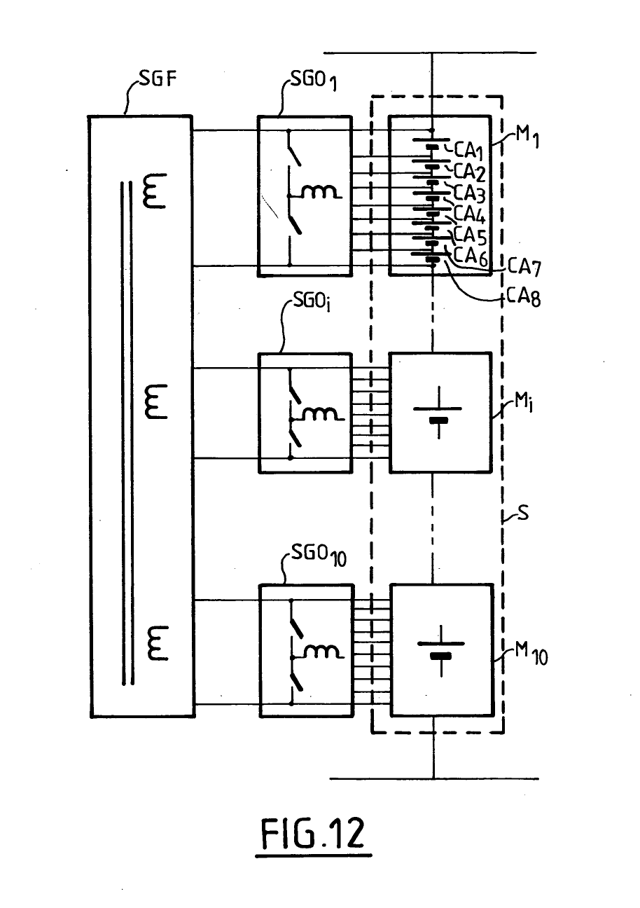

FIG. 12 shows the architecture of a management system of hierarchical type; and

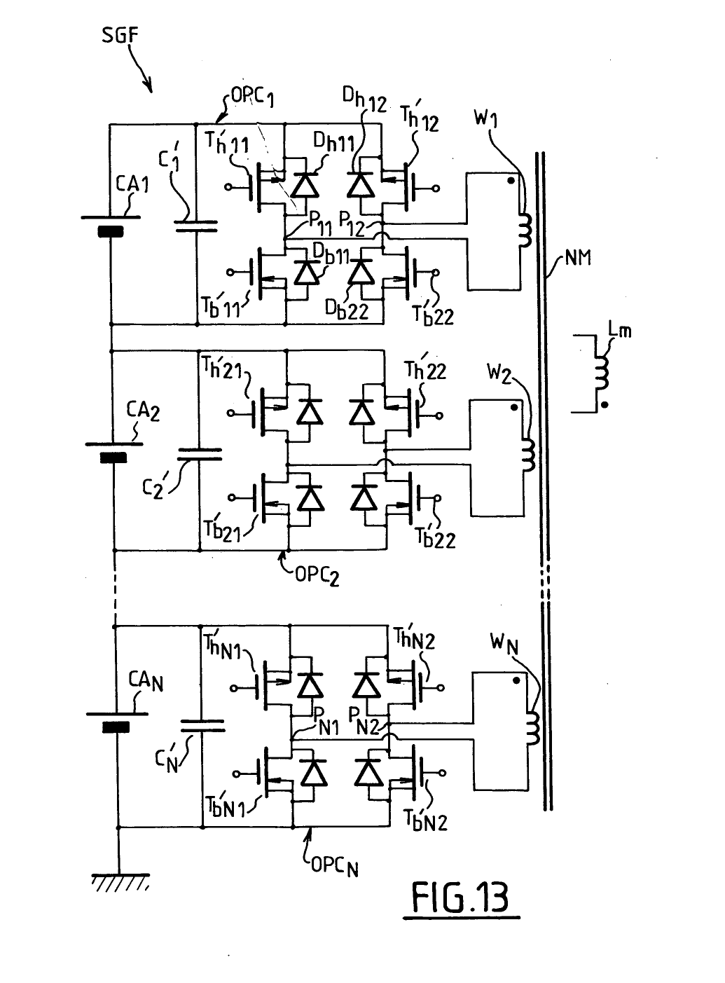

FIG. 13 is an electrical circuit diagram of a flyback equalization circuit used in the FIG. 12 hierarchical system.

FIG. 3A shows the structure of a management system in a first embodiment of the invention, i.e. the simplest embodiment. This system provides voltage equalization for a battery made up of a series association of n elements (storage cells or storage units) CA₁, . . . , CA_{R}; the positive pole of the battery is connected to a first power bar BP, and its negative pole is connected to a second power bar BP₂, which is in turn connected to ground. The voltages across the terminals of the elements CA₁, . . . , CAₙ are referenced V_{CA1}, . . . , V_{CAn}. As explained with reference to FIG. 2A, in the absence of equalization, these voltages are not necessarily equal to one another. The potential difference between the first and second power bars is:

V_{BUS}=V_{CA1}+ . . . +V_{CAn}

The management system proper has (n−1) parallel inverter arms B₁, . . . , Bₙ₋₁ that are connected between the first and second power bars. Each inverter arm Bᵢ has two switches: a “top” switch Tₕᵢ connected to the first bar and a “bottom” switch T_{bi} connected to the second bar. Between the two switches there is a midpoint PMᵢ.

The midpoint PMᵢ of the arm Bᵢ is connected to a point of the battery situated between the negative terminal of the element CAᵢ and the positive terminal of the element CAᵢ₊₁ by means of a respective inductor Lᵢ, and also connectors that are not shown in the figures. The potential of this point is written V′ᵢ. Naturally,

V′=V_{CAn}+V_{CA(n-1)}+ . . . +V_{CA(i+1)}

If all the voltages V_{CA} were equal to each other (a perfectly equalized battery), then:

$${V}_{i}^{′} = \frac{n - i}{n} {V}_{BUS}$$

Control means MC (e.g. a microprocessor) control the switches of the inverter arms in alternating manner, i.e. by ensuring that both switches Tₕ and T_{b} of any one arm are never closed simultaneously, since that would short-circuit the battery and the two power bars, which could lead to the system being destroyed.

The mean voltage Vᵢ of the midpoint PMᵢ of inverter arm Bᵢ depends on the duty ratio with which the two switches Tₕᵢ and Bₕᵢ are closed. Let αᵢ be the duty ratio of the switch Tₕᵢ (i.e. this switch is closed during a fraction αᵢ of the time, where 0≦αᵢ≦1) and let (1−αᵢ) be the duty ratio of the switch T_{bi}; it is easy to demonstrate that the voltage Vᵢ of the midpoint PMᵢ is:

Vᵢ=αᵢ·V_{BUS}

(assuming that the voltage of the first power bar is V_{BUS} and the voltage of the second power bus is 0 V).

It is possible to write:

$${α}_{i} = \frac{n - i}{n}$$

such that:

$${V}_{i} = \frac{n - i}{n} {V}_{BUS}$$

Thus, each midpoint of the system is at a voltage level equal to the level that would be had by the point of the battery to which it is connected via the inductor Lᵢ if the battery were perfectly equalized. Naturally, the duty ratio of each inverter arm is preferably controlled in a closed loop, so that the voltage or the current in the inductor is servo-controlled, which requires voltage sensors to be used in parallel with the elements CAᵢ and/or current sensors to be used in series with each inductor.

By way of example, consider a series association of seven elements (units or modules) CA₁ to CA₇. The voltage V_{BUS}=21 V, which means that the nominal voltage across the terminals of each element is equal to 3 V. However the elements are not equalized: V_{CA3}=3.6 V, while V_{CAi}=2.9 V for i=1, 2, 4-7.

The voltages Vᵢ, V′ᵢ and the potential differences Vᵢ-V′ᵢ across the terminals of the inductors Lᵢ are given by the following table:

| | | |
|---|---|---|
| V₁ = 18 V | V′₁ = 18.1 V | V₁-V′₁ = 0.1 |
| V₂ = 15 V | V′₂ = 15.2 V | V₂-V′₂ = 0.2 |
| V₃ = 12 V | V′₃ = 11.6 V | V₃-V′₃ = −0.4 |
| V₄ = 9 V | V′₄ = 8.6 V | V₄-V′₄ = −0.3 |
| V₅ = 6 V | V′₅ = 5.8 V | V₅-V′₅ = −0.2 |
| V₆ = 3 V | V′₆ = 2.9 V | V₆-V′₆ = −0.1 |

As can be seen, there exists a voltage difference across the terminals of each inductor Lᵢ; consequently, the currents I_{Li} flowing through each of said inductors vary linearly in time. If current flowing from a battery element towards the management system is taken to be positive, then it can be seen that the currents I_{L1} and L_{L2} increase while the currents I_{L3}-I_{L6} decrease. Thus:
the element CA₁ tends to be charged by the current I_{L1};
the element CA₂ tends to be charged by the current I_{L2} and discharged by nevertheless since (V₂-V′₂)>(V₁-V′₁), I_{L2} increases more rapidly than I_{L1}: overall, CA₂ is therefore charged;
the element CA₃ tends to be discharged both by I_{L2} (which is positive) and by I_{L3} (which is negative);
the element CA₄ tends to be charged by I_{L3} but discharged by I_{L4}; nevertheless, since |V₂-V′₂|>|V₄-V′₄|, the charging effect prevails and CA₄ tends to be charged;
the element CA₅ tends to be charged by I_{L4} and discharged by I_{L5}; once more, the charging effect prevails;
the element CA₆ tends to be charged by I_{L5} and discharged by I_{L6}; once more, the charging effect prevails; and
the element CA₇ tends to be charged by I_{L6}.

In conclusion, the overcharged element CA₃ tends to discharge while the other elements, which are undercharged, become charged at its expense. Overall, equalization of the battery occurs.

FIGS. 3B to 3D show the results of a simulation performed for a battery having four elements in which the element CA₂ is charged to 4.5 V while the other three elements CA₁, CA₃, and CA₄ are charged to 4 V.

FIG. 3B shows how the currents I_{CAi} flowing through the elements vary over time. It can be seen that these currents are severely chopped, with sudden variations that correspond to the switching of the switches, and with linear increases or decreases between said switching moments. In the example described here, the switching orders to the various switches are in phase. Nevertheless, that is not essential. On the contrast, it may be advantageous to control the various arms of the inverter in such a manner that they do not switch simultaneously: that makes it possible to reduce the amplitude of voltage oscillations and to reduce the capacitance of the filter capacitor C.

FIG. 3C shows how the voltages V_{CAi} across the terminals of the battery elements vary over time. It can be seen that these voltages converge towards a common value, i.e. equalization takes place. Nevertheless, it can be seen that the voltage V_{CA1} begins by dropping a little before rising towards said common value.

FIG. 3D is a graph of the currents I_{L1}-I_{L3} as a function of time. It can be seen that high frequency oscillations caused by switching the switches are superimposed on slower overall variation, with the inductors filtering these oscillations in part only.

The capacitor C filters the voltage fluctuations due to the switching.

In a prototype made using CMOS technology, such a management system consumes about 1 milliwatt (mW) when the battery elements are equalized. When lack of equalization needs to be compensated, its consumption increases, but the effectiveness of equalization (ratio of energy transfer during equalization over the sum of that energy plus the energy consumed by the system) is typically greater than 90%.

FIG. 4A is the circuit diagram of a system in a second embodiment of the invention. This system differs from that of FIG. 3A only in that it includes two additional inductors L₀ and Lₙ connected respectively between the positive terminal of the element CA, and the first power bar BP, and the negative terminal of the element CAₙ and the second power bar BP₂. Adding these additional inductors does not fundamentally change the operation of the system, but nevertheless it produces advantageous effects, as shown in FIGS. 4B-4D. These figures relate to a simulation performed under the same conditions as the simulation of FIGS. 3B-3D, i.e. for a battery having four elements with the element CA₂ being charged to 4.5 V while the other three elements CA₁, CA₂, and CA₄ are charged to 4 V.

FIG. 4B shows that the currents I_{CAi} flowing through the elements are much less chopped (i.e. much smoother) than in the above-described embodiment; in particular the sudden variations that correspond to the switching of the switches are absent. This is not surprising: in the FIG. 4A circuit all of the currents must flow through inductors: consequently, they cannot present sudden variations. Such behavior is much better from the electromagnetic compatibility point of view, and it avoids subjecting the elements to stress that they might not be able to withstand or indeed it avoids generating greater losses.

Another advantage of the FIG. 4A topology is that the sum of the currents flowing through the inductors L₀ to Lₙ is zero at all times:

$${\sum }_{i = 0}^{n} {I}_{Li} = 0$$

This makes it possible to provide the n+1 inductors in the form of windings on independent columns of a magnetic core CM having shared yokes, thereby providing a single magnetic circuit. This leads to a very compact arrangement for the inductive components of the system, as shown in FIG. 6.

A magnetic core with shared yokes may also be used for the system of FIG. 3A. Nevertheless, in that system the condition:

$${\sum }_{i = 1}^{n - 1} {I}_{Li} = 0$$

is not satisfied; consequently, it is necessary to provide a return “leg” or “column”, having no winding in order to loop the flux lines. In order to avoid any risk of the magnetic core saturating, the section of that return leg should ideally be equal to the sum of the sections of all of the other legs (each associated with a respective winding), thereby leading to a core having twice the weight. The advantage of the second embodiment of the invention is thus clear.

The third embodiment of the system of the invention as shown in FIG. 5 constitutes a development of the embodiment of FIG. 4A. It differs therefrom in that the inductors L₀ and Lₙ are not connected directly to the first and second power bars, but to the midpoints PM₂ and PMₙ of two additional inverter arms.

This enables the first power bar to be maintained at a potential higher than that of the terminals of the battery; under such circumstances, the capacitor C serves not only to perform a filtering function: it is also needed to maintain a constant potential difference between the two power bars.

Above all, this variant makes it possible to implement “forced” equalization of the elements.

The mode of operation described above may be referred to as “natural” equalization: the control module MC has no need to know the voltages across the terminals of the various elements of the battery; it controls the switches in a predefined manner, and that suffices to give rise to equalization regardless of the states of charge of said elements. In contrast, with forced equalization, the system acts specifically on elements that are overcharged in order to discharge them partially into the elements that are undercharged so as to raise their charge levels.

Equalization in the forced mode of operation may be explained with the help of an example. It is assumed that the element CA₂ is overcharged, while the element CAₙ is insufficiently charged (refer to FIG. 5).

Firstly, the switches of the arms B₁ and B₂ are controlled exactly as in the natural equalization mode, while the other switches remain open. As explained above, the currents I_{L1} and I_{L2} tend to discharge CA₂; however unlike that which occurs with natural equalization, the energy extracted from CA₂ cannot be absorbed by the other elements since they are not directly connected to the system (because the switches of the corresponding inverter arms are blocked in the open position). This energy is therefore stored in the capacitor C, thereby giving rise to a small increase in the voltage of the first power bar, which voltage is therefore no longer equal to the voltage across the terminals of the battery.

Furthermore, and simultaneously, the switches of the arms Bₙ₋₁ and Bₙ are controlled exactly as in natural equalization mode, while the other switches are left open. The currents I_{L(n-1)} and I_{Ln} tend to charge CAₙ by taking energy from the capacitor C. In general, the capacitor needs to present capacitance that is greater than in the other embodiments, in which it serves only to perform filtering.

In another example, it is possible to use active equalization to discharge the cell CA₂ for the benefit of all of the other cells CAᵢ (i≠2). Only the inverter arms B₀, B₁, B₂, and Bₙ are operated, and they are controlled in such a manner as to cause current to flow solely in the inductors L₀, L₁, L₂, and Lₙ. The inverter arms are servo-controlled in current in such a manner that the current in L₀ is one positive value unit (the current enters CA₂), the current in L₁ is n negative value units, the current in L₂ is n positive value units, and the current in Lₙ is one negative value unit. All of the other switches are open, and no current flows in the corresponding inductors. In this configuration, it can be shown that all of the elements CAᵢ (i≠2) charge at the expense of the element CA₂ alone.

Active equalization minimizes the consumption of the system since only those switches that are actually needed for equalization are switched. In addition, it enables the magnitude of charge transfer to be controlled, whereas natural equalization can lead to very high current transients, which makes it necessary to use current limiters or to overdimension the components of the equalizer system.

In contrast, active or forced equalization requires control that is more sophisticated; above all, it is necessary to provide a set of current and/or voltage sensors at the switches or at each connection between an inductor and a midpoint of the corresponding inverter arm. Whereas in natural equalization the inverter arms can be servo-controlled in voltage, possibly together with current limiting in order to avoid overloading the components, forced equalization necessarily relies on servo-controlling the electrical magnitudes associated with the cells, i.e. the voltages across their terminals, or the currents flowing through them.

Whether operating under natural or forced equalization conditions, the nominal voltage levels need not necessarily be the same for all of the elements; it suffices for these levels to be known. Thus, it is possible to perform equalization on nominal voltages that vary to take account of the temperatures of the various elements. It is also possible to manage an association of elements that are made using different technologies. Under such circumstances, it is more appropriate to speak of “charge level equalization” rather than “voltage equalization”.

Above, consideration is given solely to achieving voltage equalization of a series association of electrical energy storage elements (in particular electrochemical elements). The system of the invention may equally well be used for equalizing a series association of electrical energy generator elements, in particular of the photovoltaic type, as shown in FIG. 9.

As explained above, if one of the cells (PVᵢ) in a series association of photovoltaic cells is shaded or faulty, then it behaves as a consumer of current, and the voltage Vᵢ across its terminals becomes strongly negative. When operating in natural conditions, the management system of the invention serves to impose a positive potential difference across the terminals of that element so that it acts as a generator (even if it does so at a power level that is smaller than that of the other elements, specifically because it is shaded or faulty). Under such conditions, the current I_{PVI} flowing through the shaded or faulty element is less than the current (I_{OPTI}) flowing through all of the other elements; furthermore, a current (I_{OPTI}−I_{PVi}) flows through the inductors Lᵢ₋₁ and Lᵢ in order to “support” this element.

It is also possible to operate under forced equalization conditions: under such circumstances, the inverter arms are servo-controlled in current so as to impose a current (I_{OPTI}−I_{PVi}) in the inductors and Lᵢ₋₁ this leads to Vᵢ being adjusted automatically.

The system of the invention also makes it possible to detect cells (or groups of cells) that are faulty or shaded. In order to test the operating state of a cell PVᵢ, it suffices to control the switches of the arms Bᵢₜ and Bᵢ so as to impose a known voltage on the midpoints of each of those two arms, thereby leading to the same configuration as that shown in FIG. 9. Assuming that the voltage-current characteristic of the cell is known, measuring the currents flowing in Lᵢ₋₁ and Lᵢ serves to determine its degree of shading.

The operation may be repeated for all of the cells (or groups of cells) in the panel, and this may be done sequentially or simultaneously.

It is of interest to observe that detecting cells that are shaded or faulty does not require any additional components. It is true that sensors need to be provided for sensing the current I_{Ln}, but in general such sensors are necessary in any event for servo-controlling the management system.

A system of the invention also serves to equalize sets of photovoltaic cells taken collectively, such as solar panels, for example. By way of example, FIG. 10A shows a set of four photovoltaic panels PPV₁-PPV₄ that are connected in series with one another and that are connected to two power bars BP₁ and BP₂. In principle, management of the equalization of these panels relies on exactly the same considerations as equalizing cells within a given panel.

In the circuit of FIG. 10B, the panels are equalized by means of a management system SG of the invention that is provided in centralized manner, i.e. that incorporates all of the inverter arms. This solution is nevertheless penalized by complex connections. FIG. 10C shows a decentralized configuration in which each inverter arm B₁-B₃ is implemented close to the photovoltaic panel with which it is associated. In this embodiment, in order to avoid problems associated with switching loops of large area and thus of large inductance, it is preferable for a respective capacitor C₁, C₂, and C₃ to be associated with each inverter arm, in the immediate proximity thereof.

Whatever the embodiment used, the active portion of a system of the invention is constituted essentially by a plurality of inverter arms in parallel, each having two controlled switches that are generally implemented in the form of transistors, e.g. of the metal oxide semiconductor field effect transistor (MOSFET) type, as shown in FIGS. 8A and 8B. An embodiment in the form of complementary MOSFETs (CMOS technology) is particularly preferred; that technology enables the close control of the power transistors to be powered directly from the positive voltage power bar. In the embodiment of FIG. 8B, the switches Tₕ are N-MOSFETs having their drains connected to the first power bar BP₁ and their sources connected to the midpoints PM, while the switches T_{b} are P-MOSFETs connected by their drains to the second power bar BP₂ and by their sources to the midpoints PM. The P-MOSFETs need to be of greater area than the N-MOSFETs because of their lower conductivity. In the embodiment of FIG. 8A, both transistors are connected to the midpoint PM via their drains; in this configuration, the switch Tₕ is a P-MOSFET and the transistor T_{b} is an N-MOSFET. This configuration enables the control of the system to be simplified since the control signals (applied to the grids of the transistors) are referenced to a common voltage level (that of the sources) for all of the half-arms.

So long as only relatively modest voltages and/or powers are involved, it is possible to use conventional components of lateral structure. Making the system in integrated form then does not raise any particular difficulty.

In contrast, in applications involving higher voltages and/or powers, it is necessary to use components that are of vertical structure, where such components are problematic to integrate. Nevertheless, all (or some) of the transistors of a given type—P or N—can be made on a single chip; in this way, the system, or at least its active power portion, may be in the form of a two-chip module. Making a set of inverter arms in the form of a two-chip module is described in detail in document WO 2011/004081 and also in document US 2008/0135932. A particular and non-limiting example of a two-chip module is described below in outline with the help of FIGS. 7A and 7B.

FIG. 7A is a section view of a portion of a semiconductor chip for use in making such a two-chip module.

This chip comprises a first substrate S₁ made of semiconductor material (typically silicon) that is degenerate, i.e. that presents a high concentration of dopants—specifically electron donors—giving it quasi-metallic conductivity. The thickness of the first substrate S₁ is typically of the order of 500 micrometers (μm) so as to give it sufficient mechanical strength during fabrication. A layer of metalization MD is formed on the so-called “rear” face of the substrate.

On the “front” face of the substrate S₁, i.e. its face opposite from said rear face, there is deposited an epitaxial layer S₂ of semiconductor material, within which the electronic power devices are to be made. This layer presents doping of the same type as the first substrate, but at a lower concentration (N−). The thickness of this layer S₂ is typically about 50 μm or less.

By entirely conventional photolithographic techniques on the “front” face, electronic devices such as N-channel MOSFETs (symbol on the right of the figure) are made within the epitaxial layer S₂. For example, as shown in FIG. 7A, P-doped “body” regions RC and N+-doped contact regions CO are made on the surface of said layer. The body and contact regions define channel regions CH on which polysilicon grid electrodes CG are made that are insulated by insulating oxide layers. Metalization MS is deposited on the contact regions CO. In known manner, such metalization is used for making contact with the sources of the various MOSFET cells (or the emitters if the devices are IGBTs), whereas the layer of metalization MD on the rear face provides a common drain contact (or common collector contact for IGBTs).

The channel regions CH and the body regions RC form the “active” zones of the devices. The deepest portion of the layer S₂ extending from the interface with the substrate S₁ constitutes the voltage-blocking or diffusion zone ZD. In a manner that is conventional in power electronics, each transistor may be made up of a plurality of “elementary cells”, each of which has its own body region RC with P doping and one or two contact regions CO with N+ doping.

The voltage-blocking and active regions of the devices made in this way are insulated from one another by trenches TP, made by deep etching using reactive ion beams and filled with dielectric (generally but not necessarily with SiO₂). These trenches do not extend into the substrate S₁, or they extend into it only over a fraction of its depth: consequently, the drains of all of the transistors on the chip are electrically connected together and maintained at the same potential. This is not a drawback in the application under consideration, where all of the drains of the N type (or P type) transistors need to be connected to the first (or second) power bar.

The trenches TP perform two functions. Firstly, as mentioned above, they serve to isolate the various devices that need to be able to switch independently of one another; secondly they provide equipotential termination for the edges of the voltage-blocking region. This second function is important and merits attention being given thereto. The voltage-blocking region ZD is the portion of the device in which most of the ability to block voltage occurs between the drain and the source (for a field effect transistor). In this region, equipotential surfaces are approximately plane. The device is dimensioned so as to prevent any breakdowns occurring within the voltage-blocking zone; nevertheless, there is a danger of breakdowns occurring on the sides of the device, at surface defects. That is why it is necessary to define the voltage-blocking zone by trenches that present side surfaces that are smooth and that are filled with a dielectric that is sufficiently rigid (in particular SiO₂ by chemical vapor deposition). In this context, reference may be made to the article by Philippe Leturcq “Tenue en tension des semi-conducteurs de puissance” [Breakdown voltage of power semiconductors], D 3 104-1, Techniques de l′ingénieur, traité génie électrique.

Simulations show that the ability of devices to withstand voltage is maximized when the trenches flare a little, such that the side surface of the zone ZD forms an angle of about 100° relative to the S₁/S₂ interface. Under such conditions, the equipotentials leaving the zone ZD curve downwards (towards said interface S₁/S₂) before rising towards the front surface of the chip.

Consideration is given above solely to monolithic integration of the devices that make up the “top” half (transistors Tₕ) of a set of parallel bridge arms. The “bottom” half (transistors T_{b}) is integrated in a chip having the same structure as that shown in FIG. 7A, but using substrates S₁, S₂ of P type in order to make P-channel transistors.

After making the two chips P₁ and P₂ separately that incorporate in monolithic manner the switches of the top and bottom portions of the module respectively, it is necessary for them to be electrically and mechanically connected together so as to form the switch pairs that constitute each bridge arm. The most advantageous technique consists in a three-dimensional stack as shown in FIG. 7B.

The power module shown in section in this figure is obtained by superposing two chips, each incorporating a plurality of switches in such a manner that the “free” terminals of the switches of the first chip are arranged facing the corresponding free terminals of the switches of the second chip, so as to form bridge arms.

From top to bottom, the stack of FIG. 7B comprises:
A conductor element BV+ for connection to the first power bar BP₁ that is maintained at a positive voltage.
A first semiconductor chip P₁ of N type comprising a first degenerate substrate S₁N that is electrically in contact with the element BV+ and an epitaxial layer S₂N having vertical structure N-MOSFETs made therein (reference T). As explained with reference to FIG. 7A, the drains of these transistors are maintained at a common potential by the first degenerate substrate S₁N and by the conductor element BV+. The active zones and the voltage-blocking zones of the transistors are spaced apart from one another by isolating furrows SI that produce “mesa” type terminations.
A source metalization layer MS1 that is made discontinuous by the isolation furrows.
Electrical connection elements BS, that are generally made of metal, constituting the output terminals of the module.
A metalization layer MD2, also made discontinuous by the isolation furrows, for interconnecting drains of the P-MOSFETs forming the bottom portions of the set of bridge arms.
A second semiconductor chip P₂ of P type, comprising an epitaxial layer S₂P having vertical structure P-MOSFETs made therein and a first degenerate substrate S₁P. An N-MOSFET of the first chip and a P-MOSFET of the second layer form a bridge arm with its midpoint coinciding with an output terminal BS. The sources of the P-MOSFETs are connected to the corresponding output terminals by respective metalization layers MD2.
A conductor element BV− in electrical contact with the degenerate substrate S₁P, and thus with the drains of the P-MOSFETs, for connection to the second power bar BP₂, that is maintained at a voltage that is negative relative to said first bar BP₁.

Assembly may be provided by soldering, adhesive, or clamping.

The above description for MOSFETs applies equally to other types of semiconductor device suitable for making controlled switches (IGBTs, thyristors, . . . ). It is not essential to use a structure that is complementary.

In known manner, the control signals issued by the control means MC are not applied directly to the grids of the transistors in the inverter arms, but they are used rather to control nearby control circuits that in turn generate the signals for ensuring that the power devices switch cleanly. The nearby control circuits may be co-integrated with the vertical structure power transistors.

A management system in any of the embodiments of the invention as described above comprises n−1 to n+1 inductors and 2(n−1) to 2(n+1) switches, where n is the number of elements for storing or generating electrical energy, plus the capacitor C and connections. The switches are capable of being integrated in effective manner, and it is the inductors that contribute most to the weight and the bulk of the system. It is necessary to ensure that the ferromagnetic core of each inductor is of a section that is sufficient to avoid any risk of saturation. The minimum section that is required depends on the maximum current that might flow through the inductor, and in turn that depends on the inverter arm to which it is connected. FIGS. 11A and 11B show alternative embodiments that, in spite of an apparent increase in the complexity of the management system, nevertheless enable the bulk and the weight of its reactive elements to be reduced significantly.

As shown in FIG. 11A the idea essentially consists in replacing each inverter arm (only one arm, Bᵢ, is shown in the left-hand portion of the figure), by N “individual” arms that are connected in parallel (N=4 in the figure), given references Bᵢ¹-Bᵢ⁴ (right-hand portion of the figure). Each of these arms has a midpoint PMᵢ¹-PMᵢ⁴ having a first terminal of a respective inductor Lᵢ¹-Lᵢ⁴ connected thereto. The second terminals of the inductors Lᵢ¹-Lᵢ⁴ are connected together so as to be connected to the same point of the series association of storage or generator elements. The signals for controlling the switches Tₕᵢ¹-Tₕᵢ⁴, T_{bi}¹-T_{bi}⁴, in the individual arms Bᵢ¹-B₁⁴ that replace a given inverter arm Bᵢ are offset by a fraction 1/N of a period (here 1/N=¼). Although the number of inductors in the management system is increased by a factor N, current ripple is reduced, thereby enabling their overall size to be reduced.

The reduction in the size of the inductors is optimum when the number N of individual arms is equal to the number n of electrical energy storage or generator elements in the association; under such conditions, the control signals for the switches in each inverter arm present duty ratios of values lying in the range 1/n to (n−1)/n—i.e. from 1/N to (N−1)/N.

The embodiment of FIG. 11A is thus particularly suitable for managing series associations having a relatively limited number of elements, typically up to ten.

The control signals Sₕ₄¹-Sₕ₄⁴ for the “top” switches Tₕ₄¹-Tₕ₄⁴ are shown in FIG. 11C; it can be seen that with N equal to 4, these signals are offset by one-fourth of a period. All of these signals have the same duty ratio that in this particular element is ¼ (i=4; these are thus individual arms connected to the positive terminal of the first storage element starting from the power bar PB₂). The control signals for the “bottom” switches T_{b4}¹-T_{b4}⁴ are complementary to the signals Sₕ₄¹-Sₕ₄⁴.

The size of the inductors Lᵢ¹-Lᵢ⁴ may subsequently be reduced by using cyclic cascade coupling, as shown in FIG. 11B. Under such circumstances, the inductor of each individual arm is coupled with the neighboring inductors via simple magnetic cores having two windings. Where necessary—and as often happens in practice—a leakage leg may be provided for each couple winding pair in order to provide effective filtering when the control signals are not exactly offset by 1/N or when their value is not exactly a fraction of N, e.g. for servo-control reasons. This makes it possible to loop magnetic field lines that are not common to the two windings coupled on a given magnetic core.

In the management systems of the invention, each inverter arm needs to withstand the entire potential difference across the terminals of the series association being managed. As a result, the architecture based on a plurality of voltage inverter arms in parallel is particularly well suited to applications at relatively low voltages, e.g., and with reference to FIG. 1, for equalizing storage units CA constituting a module M. Advantageously, a different management system may be used for equalizing the various modules that are connected in series to constitute a stack S, in the context of an overall management system of the hierarchical type.

FIG. 12 is a highly diagrammatic view of such a system, in which management systems SGO₁, . . . , SGOᵢ, . . . , SGO₁₀ of the type shown in FIG. 3A are used for equalizing the storage units CA₁-CA₈, each having ten modules M₁, . . . , MOᵢ, . . . , M₁₀ constituting a stack S. Equalization between the modules, each considered as being indivisible, is performed by a management system based on flyback type converters SGF as described below. Such a hierarchical solution presents two advantages:
Each inverter arm needs only to withstand the voltage generated by a single module. If a system of the type shown in FIG. 3A were used for equalizing the entire stack, then the potential difference across the terminals of its inverter arms would be ten times higher, which would make monolithic integration of said arms more difficult and would lead to inductors of much greater size.
The management systems SGO₁-SGO₁₀ may be of the type shown in FIG. 11A or 11B. Given that each module has n=8 units, the number N of individual arms is N=8, giving a total Nn=64 inductors per module, and thus 640 inductors for the entire stack (to which it is necessary to add the ten flyback type windings of the management system). If it were desired to equalize the entire stack—comprising 80 cells in series—with a system having the architecture of FIG. 11A, it would then be necessary to use 80×80=6400 inductors, i.e. ten times more.

The advantage of the hierarchical approach is thus clear.

The flyback type management system SGF shown in FIG. 12 is described in detail in French patent application FR 10/00671 of Feb. 17, 2010. Its structure and its operation are also described below with reference to FIG. 13. As shown in FIG. 13, an equalizer system of the invention associates each module M₁, M₂, . . . , M_{N} with a full bridge inverter and a magnetic coupler winding.

Each full bridge inverter OPC₂, OPC₂, . . . OPC_{N} is constituted by the parallel association of two bridge arms, with the end ports thereof being connected to the terminals of the corresponding battery elements by respective connectors; each bridge arm is in turn constituted by two switches in series. In the embodiment described herein, the bridge arms are made using CMOS technology: the “top” switch (for connection to the positive terminal of the battery element) in each arm is a P-MOS switch, while the corresponding “bottom” switch (for connection to the negative terminal of the battery element) is an N-MOS switch. In the figure, T′ₕₙₘ and T′_{bnm} designate respectively the top switch and the bottom switch of arm No. n (n=1 or 2) in the inverter associated with battery element No. m (m=1 to N). The body diodes of the transistors are referenced Dₕₙₘ.

The midpoints P₁ᵢ, P₂ᵢ of the arms (where i is the index of the inverter) are connected to respective windings Wᵢ made on a common magnetic core NM that provides magnetic coupling between all of the windings. The magnetic core NM and the windings Wᵢ form a magnetic coupler connecting all of the inverters together.

The reference Lₘ identifies the magnetizing inductance of the coupler.

A respective capacitor C′₁, . . . C′_{N} is connected in parallel with each module of the stack. Its function is mainly to filter the high frequency components created by the chopping electrical magnitudes (voltages, currents) caused by the transistors switching. As discussed below, each capacitor also serves to ensure continuity in the power supply to the inverter and the associated electronics.

It is of interest to observe that the active portion of the FIG. 13 flyback management system is constituted by pairs of inverter arms connected between the terminals of each module. It means that it is extremely simple to use the two-chip technique for co-integrating a management system SGOᵢ and the corresponding inverter of the system SGF: it suffices to add two inverter arms to each two-chip module of the type shown in FIG. 7B.

The FIG. 13 flyback system can operate under “natural” equalization conditions. Under such conditions, all of the inverters are controlled synchronously by a pulse width modulation control signal having a duty ratio equal to 0.5, and preferably at a frequency greater than 20 kilohertz (kHz), i.e. above the audible threshold so as to avoid generating sound nuisance.

In a first half of the cycle, the bottom switch of the first arm and the top switch of the second arm in each inverter are closed; in the second half of the cycle, it is the top switch of the first arm and the bottom switch of the second arm that are closed.

During the first half-cycle, the modules that are the most charged tend to discharge through their respective windings, thereby generating varying magnetic flux in the magnetic core NM, which in turn generates current in each of the windings of the modules that are less charged, tending to charge said modules.

The problem is that some of the current that flows charges the magnetizing inductance Lₘ of the magnetic coupler formed by the magnetic core and the various windings. In order to avoid this inductance saturating, after a certain length of time (a few tens of microseconds) it is necessary to reverse the bias applied to the windings in order to ensure that the mean voltage at their terminals is zero: the switches that were closed during the first half of the cycle are open and those that were open are closed. The currents flow in opposite directions, but energy continues to be transferred from the more charged modules towards the modules that are less charged. In addition, the energy stored in the magnetizing inductance Lₘ of the coupler is released and then stored once more in the form of a current flowing in the opposite direction.

“Natural” equalization does not necessarily apply to all of the modules of the stack: it is possible to control only a subset of the inverters, leaving the others in an open configuration so that they decouple the corresponding modules of the equalizing system. Under such circumstances, equalization takes place only between the modules that are associated with the active inverters.

There is also another mode of operation that may be referred to as “forced”, that transfers energy indirectly with energy being stored temporarily by the magnetizing inductance Lₘ. This mode of operation takes place in two stages. In the first half-cycle, only one inverter (or a plurality of inverters associated with modules charged to voltage levels that are close together, having differences of a few millivolts at most) is operated while the others are inactive and isolate the respective battery elements from the magnetic coupler. The inverter that is controlled is associated with a module that needs to be discharged in part in order to transfer its excess charge to other elements. Two switches of the inverter are closed so as to allow electric current to flow through the winding (e.g. the top switch of the second arm and the bottom switch of the first arm). Since the other windings of the magnetic coupler are open-circuit, this current serves entirely to charge the magnetizing inductance Lₘ.

In the second half-cycle, the switches of the inverter that were previously operated are opened whereas the inverters associated with battery elements for receiving additional charge are operated so as to extract the energy that was accumulated by the magnetizing inductance during the first half-cycle.

Forced equalization is more complex to perform than natural equalization. Furthermore, if this control is not performed properly, it runs the risk of leading to “over-equalization” i.e. to overcharging of one or more modules that were initially undercharged.

Its strong point is represented by its flexibility: it makes it possible to transfer energy from a determined module to one or more other modules in controlled manner. In addition, in particular circumstances “over-equalization” may be intentional, e.g. if it is desired to “anticipate” the weakness of a module during discharging (by overcharging it—without exceeding safety limits—in order to compensate for the fact that it will discharge more quickly than other elements).

In contrast, forced equalization cannot operate if the potential difference between the most charged modules and the least charged modules is too great, typically greater than about 1.4 V. It must not be forgotten that the inverters are not constituted by switches that are ideal, but rather by power transistors that have an anti-parallel body diode. If V_{CA1}-V_{CA3} is greater than about 1.4 V (twice the activation voltage of the diodes), they become conductive in untimely manner, which is incompatible with the above-described operating scheme.

Forced equalization can also be performed by using a plurality of donor elements—providing they are all charged to the same voltage level—and a plurality of receiver elements—even if they are charged to different voltage levels.

There is also a third way of controlling the system of the invention that may be referred to as “mixed”. This method of control differs from natural equalization solely in that a varying phase shift is introduced between the control signals for the various inverters. With natural equalization, energy transfer takes place mainly directly via the coupler, without inductive storage; with forced equalization, energy is transferred essentially via the magnetizing inductance of the coupler; with mixed equalization, direct transfer of energy between cells is likewise performed, but its magnitude and its direction may be adjusted to take account of the leakage inductance in series with the coupler. This adjustment is performed by introducing a phase shift between the control signals for the various inverters.

Document U.S. Pat. No. 6,873,134 describes another type of flyback equalizer that uses half-bridge inverters instead of full-bridge inverters as in the system of FIG. 13. Such an equalizer can likewise be used in a hierarchical system of the type shown in FIG. 12.

The hierarchical architecture of FIGS. 12 and 13 is described above with reference to its application to a battery, however it can equally well be applied to other systems for generating or storing electrical energy providing they present a structure that is modular, such as solar panels.

1. A management system for managing a series association of elements for storing or generating electrical energy (CA1-CAn; PV1-PVn), the system being characterized in that it comprises:
first and second power bars (BP1, BP2);
a plurality of inverter arms (B0-Bn) connected in parallel between said first and second power bars, each inverter arm being in turn constituted by two switches (Th1, Tb1) connected in series via a midpoint (PM1) of the arm;
a plurality of inductors (L0-Ln), each connected to the midpoint of a respective inverter arm; and
a plurality of connectors for connecting the midpoint of each inverter arm to said series association between two adjacent elements via a respective one of said inductors.

2. A management system according to claim 1, also including a first connector for connecting the first power bar to a positive terminal of the electrical energy storage element situated at a positive end of said series association, and a second connector for connecting the second power bar to a negative terminal of the electrical energy storage element situated at a negative end of said series association.

3. A management system according to claim 2, also including two inductors (L1-Ln) connected in series with said first and second connectors.

4. A management system according to claim 1, also including:
an inverter arm (B0) connected between said first and second power bars, with its midpoint (PM0) being connected via a respective inductor (L0) to a positive terminal of the electrical energy storage and/or generator element (CA1) situated at a positive end of said series association;
an inverter arm (Bn) connected between said first and second power bars, with its midpoint (PMn) connected via a respective inductor (Ln) to a negative terminal of the electrical energy storage and/or generator element (CAn) situated at a negative end of said series association; and
a capacitor (C) also being connected between said first and second power bars.

5. A management system according to claim 1 wherein said inductors all present the same inductance value.

6. A management system according to claim 5, wherein said inductors are made in the form of coils around respective columns of a magnetic core (NM) having yokes in common, thus providing a single magnetic circuit.

7. A management system according to claim 1 also including a capacitor (C) connected between said first and second power bars.

8. A management system according to claim 1, also including control means (MC) for controlling the switches of all or some of said inverter arms in alternating manner with a duty ratio selected in such a manner as to determine a mean voltage level for the midpoint of each of said inverter arms that is equal to a predetermined nominal voltage level.

9. A management system according to claim 1, also including control means (MC) for controlling the switches of all or some of said inverter arms in alternating manner with a duty ratio selected in such a manner as to determine a level of current flowing through the midpoint of each of said inverter arms that is equal to a predetermined nominal current level.

10. A management system according to claim 1, wherein:
the switches of said inverter arms are made in the form of semiconductor devices that are of vertical structure; and
at least a plurality of said inverter arms are made in the form of two-chip modules comprising a first chip (P1) monolithically integrating the switches connected between the first power bar and the respective midpoints, and a second chip (P2) monolithically integrating the switches connected between said respective midpoints and the second power bar.

11. A management system according to claim 1, wherein N of said inverter arms (Bi1-Bi4), where N>1, are connected via their respective midpoints (PMi1-PMi4) and via respective inductors (Li1-Li4) to each of said connectors.

12. A management system according to claim 11, also including control means for periodically operating the inverter arms connected to a common conductor with an offset of 1/Nth of a cycle.

13. A management system according to claim 11, in which N is equal to the number of electrical energy storage or generator elements in said series association.

14. A hierarchical system for managing a series association (S) of electrical energy storage or generator modules (M), each module being in turn constituted by a series association (CA) of electrical energy storage or generator elements, said system comprising:
a plurality of management systems (SGO1-SGO10) according to any preceding claim for managing respective modules; and
a management system (SGF) based on flyback type converters for managing the series association of said modules, each being considered as being indivisible.

15. A hierarchical system for managing a series association (S) of electrical energy storage or generator modules (M) according to claim 14, wherein said management system (SGF) based on flyback type converters comprises:
a plurality of full-bridge inverters (OPC1, OPC2, OPCN), each of which is constituted by two inverter arms connected in parallel between two end ports of the inverter, each inverter arm being in turn constituted by two switches (Th1, Tb1; Th2, Tb2) connected in series by a said midpoint (P11, P12) of the arm;
a plurality of connectors for connecting the two end ports of each full-bridge inverter to a respective element (CA1, CA2, CAN) of said series association; and
a magnetic coupler (NM) formed by a magnetic core having a plurality of windings (W1, W2, WN) made thereon, each of said windings being connected to the midpoints of the arms of one of said inverters.

16. A series association of electrochemical elements for storing electrical energy, the association including a management system according to claim 1.

17. (canceled)

18. A photovoltaic panel comprising a series association of photovoltaic cells (PV1-PVN), connected to a management system according to claim 1.

19-20. (canceled)

21. A set of photovoltaic panels (PPV1-PPV3) connected to a management system according to claim 1.
